(19) United States
(12) Patent Application Publication
(10) Pub. No.: US 2026/0237692 A1
(43) Pub. Date: Aug. 13, 2026

(54) FUEL CELL SYSTEM

(71) Applicant: TOYOTA JIDOSHA KABUSHIKI KAISHA, Toyota-shi (JP)

(72) Inventor: Fumiaki Takasaki, Toyota-shi (JP)

(73) Assignee: TOYOTA JIDOSHA KABUSHIKI KAISHA, Toyota-shi (JP)

(21) Appl. No.: 19/421,327

(22) Filed: Dec. 16, 2025

(30) Foreign Application Priority Data
Feb. 13, 2025 (JP) 2025-021525

(51) Int. Cl. H01M 8/04029

(52) U.S. Cl. CPC H01M 8/04029

(57) ABSTRACT

The fuel cell system disclosed in the present specification includes a cooling flow passage through which coolant circulates, a fuel cell stack provided on the cooling flow passage, and a first auxiliary machine provided on the cooling flow passage, the first auxiliary machine including a metal component that comes into contact with the coolant. The cooling flow passage includes a stack flow passage in which the fuel cell stack is disposed and a first flow passage in which the first auxiliary machine is disposed. A part of the first flow passage includes a first metal pipe and a second metal pipe. The first auxiliary machine is disposed between the first metal pipe and the second metal pipe in the first flow passage. The first metal pipe and the second metal pipe are configured to be grounded.

### CROSS-REFERENCE TO RELATED APPLICATION

This application claims priority to Japanese Patent Application No. 2025-021525 filed on Feb. 13, 2025. The disclosure of the above-identified application, including the specification, drawings, and claims, is incorporated by reference herein in its entirety.

### BACKGROUND

### Technical Field

The technology disclosed in the present specification relates to a fuel cell system.

### Description of Related Art

Japanese Unexamined Patent Application Publication No. 2004-234881 (JP 2004-234881 A) discloses a fuel cell system. The fuel cell system includes a cooling flow passage through which coolant circulates, a fuel cell stack provided on the cooling flow passage, and an auxiliary machine provided on the cooling flow passage and including a metal component that comes into contact with the coolant. The cooling flow passage includes a stack flow passage in which the fuel cell stack is disposed and an auxiliary machine flow passage in which the auxiliary machine is disposed.

### SUMMARY

In the fuel cell system, the auxiliary machine disposed in the same cooling flow passage as the fuel cell stack may be charged through the coolant. In the fuel cell system of JP 2004-234881 A, the auxiliary machine is electrically connected to the ground via a wiring. That is, the auxiliary machine is configured to be grounded. As a result, the charging of the auxiliary machine is suppressed. However, direct grounding of the auxiliary machine may be difficult.

The present specification provides a technology capable of avoiding or suppressing the charging of the auxiliary machine.

In a first aspect of the present technology, the fuel cell system may include:

a cooling flow passage through which coolant circulates;

a fuel cell stack provided on the cooling flow passage; and

a first auxiliary machine provided on the cooling flow passage,

the first auxiliary machine including a metal component that comes into contact with the coolant.

The cooling flow passage may include a stack flow passage in which the fuel cell stack is disposed and a first flow passage in which the first auxiliary machine is disposed.

A part of the first flow passage may include a first metal pipe and a second metal pipe.

The first auxiliary machine may be disposed between the first metal pipe and the second metal pipe in the first flow passage.

The first metal pipe and the second metal pipe may be configured to be grounded.

In the above configuration, the first metal pipe and the second metal pipe are disposed in the cooling flow passage positioned between the fuel cell stack and the first auxiliary machine. Since the first metal pipe and the second metal pipe are configured to be grounded, the first auxiliary machine can be indirectly grounded through the coolant. Therefore, the first auxiliary machine disposed in the same cooling flow passage as the fuel cell stack can avoid or suppress charging.

According to a second aspect, in the first aspect, the fuel cell system may further include

a second auxiliary machine provided on the cooling flow passage, the second auxiliary machine including a metal component that comes into contact with the coolant.

The cooling flow passage may further include a second flow passage in which the second auxiliary machine is disposed.

The first metal pipe may be a metal joint component connecting a first end of the stack flow passage, a first end of the first flow passage, and a first end of the second flow passage to each other.

It is desirable that, in the second flow passage, a metal pipe configured to be grounded is disposed on a first end side of the second flow passage with respect to the second auxiliary machine. According to the above configuration, the number of metal pipes can be reduced as compared to a configuration in which the metal pipe is provided on both a first end side with respect to the second auxiliary machine in the second flow passage and a first end side with respect to the first auxiliary machine in the first flow passage.

According to a third aspect, in the second aspect, the fuel cell system may further include a third auxiliary machine that is provided on the second flow passage, the third auxiliary machine including a metal component that comes into contact with the coolant.

The third auxiliary machine may be configured to be grounded.

The second auxiliary machine may be disposed between the third auxiliary machine and the first metal pipe in the second flow passage.

In the above configuration, the first metal pipe and the third auxiliary machine are disposed in the cooling flow passage positioned between the fuel cell stack and the second auxiliary machine. Since the first metal pipe and the third auxiliary machine are configured to be grounded, the second auxiliary machine can be indirectly grounded through the coolant. Therefore, the second auxiliary machine disposed in the same cooling flow passage as the fuel cell stack can avoid or suppress charging. Therefore, the metal pipe may not be provided on a second end side with respect to the second auxiliary machine in the second flow passage. Therefore, the number of metal pipes can be reduced.

According to a fourth aspect, in the second aspect, the second metal pipe may be a metal joint component connecting a second end of the stack flow passage, a second end of the first flow passage, and a second end of the second flow passage to each other.

According to the above configuration, the number of metal pipes can be reduced as compared to a configuration in which the metal pipe is provided on both a second end side with respect to the second auxiliary machine in the second flow passage and a second end side with respect to the first auxiliary machine in the first flow passage.

According to a fifth aspect, in any one of the first to fourth aspects, the first auxiliary machine may be an intercooler, a radiator, or another heat exchanger.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a configuration of a fuel cell system 2 according to a first embodiment;

FIG. 2 is a diagram schematically showing a configuration of a fuel cell system 202 according to a second embodiment;

FIG. 3 is a diagram schematically showing a configuration of a fuel cell system 302 according to a third embodiment; and

FIG. 4 is a diagram schematically showing a configuration of a fuel cell system 402 according to a fourth embodiment.

### DETAILED DESCRIPTION OF EMBODIMENTS

### First Embodiment

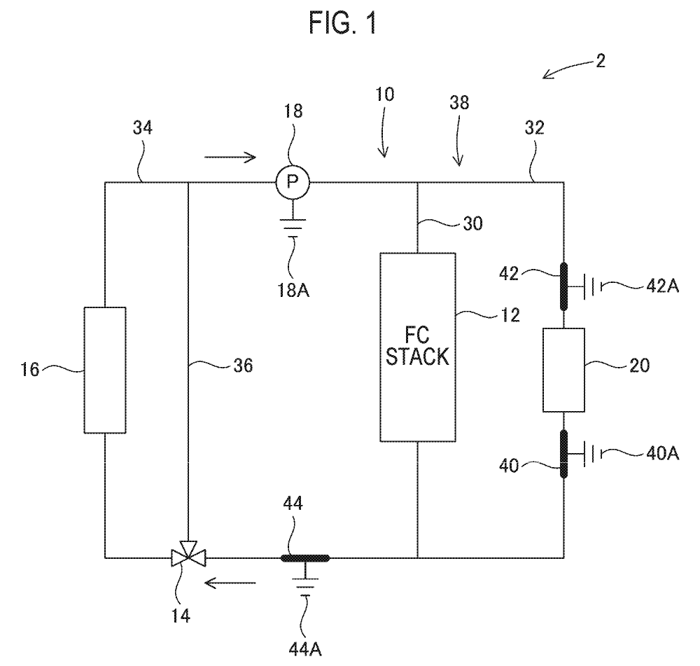

The fuel cell system 2 of the present embodiment will be described with reference to FIG. 1. Hereinafter, the “fuel cell” will be described as “FC”. Although it is an example, the FC system 2 is mounted on a fuel cell electric vehicle.

The FC system 2 includes a cooling flow passage 10 through which coolant circulates, an FC stack 12, a three-way valve 14, a radiator 16, a pump 18, and an intercooler 20.

The FC stack 12, the three-way valve 14, the radiator 16, the pump 18, and the intercooler 20 are provided on the cooling flow passage 10. The radiator 16, the pump 18, and the intercooler 20 include a metal component that comes into contact with the coolant. The three-way valve 14 is made of a resin. That is, the three-way valve 14 does not include a metal component that comes into contact with the coolant. In the modification, the three-way valve 14 may include a metal component that comes into contact with the coolant.

The FC stack 12 includes a plurality of fuel cells. Each fuel cell generates power by causing hydrogen and oxygen to chemically react with each other. That is, the FC stack 12 generates power by converting the chemical energy of hydrogen and oxygen into electrical energy. The radiator 16 cools the coolant by heat exchange with outside air. The intercooler 20 is supplied with the coolant and the compressed air supplied from the air compressor. The intercooler 20 cools the compressed air by heat exchange with the coolant.

The cooling flow passage 10 includes a stack flow passage 30, a first flow passage 32, a second flow passage 34, and a first bypass flow passage 36. The cooling flow passage 10 includes a plurality of insulating pipes 38 and a plurality of metal pipes. In FIGS. 1 to 4, the insulating pipe 38 is indicated by a thin line, and the metal pipe is indicated by a thick line. The metal pipe is a joint component that connects two or more insulating pipes 38. The insulating pipe 38 is made of an insulating material such as a synthetic resin. The metal pipe is made of a metal material such as steel, stainless steel, and aluminum.

The FC stack 12 is provided in the stack flow passage 30. The stack flow passage 30 includes the insulating pipes 38.

The stack flow passage 30 and the first flow passage 32 are connected in parallel to each other. The intercooler 20 is provided in the first flow passage 32. The first flow passage 32 includes the insulating pipes 38, a first metal pipe 40, and a second metal pipe 42. That is, a part of the first flow passage 32 includes the first metal pipe 40 and the second metal pipe 42. The second metal pipe 42 is provided on the upstream side of the first metal pipe 40. The first metal pipe 40 and the second metal pipe 42 connect two insulating pipes 38 constituting the first flow passage 32. The intercooler 20 is disposed between the first metal pipe 40 and the second metal pipe 42. The first metal pipe 40 and the second metal pipe 42 are configured to be grounded. Specifically, the first metal pipe 40 and the second metal pipe 42 are electrically connected to grounds 40A, 42A, respectively. Although it is an example, an earth line is connected to the first metal pipe 40 and the second metal pipe 42 by using a nut or the like.

The three-way valve 14, the radiator 16, and the pump 18 are provided in the second flow passage 34. The radiator 16 is provided on the downstream side of the three-way valve 14. The pump 18 is provided on the downstream side of the radiator 16. The downstream end of the stack flow passage 30 and the downstream end of the first flow passage 32 are connected to the upstream end of the second flow passage 34. The upstream end of the stack flow passage 30 and the upstream end of the first flow passage 32 are connected to the downstream end of the second flow passage 34. The second flow passage 34 includes the insulating pipes 38 and a third metal pipe 44. That is, a part of the second flow passage 34 includes the third metal pipe 44. The third metal pipe 44 is disposed on the upstream side of the three-way valve 14. The third metal pipe 44 and the pump 18 are configured to be grounded. Specifically, the third metal pipe 44 and the pump 18 are electrically connected to grounds 44A, 18A, respectively.

The upstream end of the first bypass flow passage 36 is connected to the three-way valve 14. The downstream end of the first bypass flow passage 36 is connected to the second flow passage 34 between the radiator 16 and the pump 18. The first bypass flow passage 36 includes the insulating pipe 38. The three-way valve 14 can be switched between a first communication state and a second communication state. The first communication state is a state in which the second flow passage 34 on the upstream side of the three-way valve band the first bypass flow passage 36 communicate with each other. The second communication state is a state in which the second flow passage 34 on the upstream side of the three-way valve 14 and the second flow passage 34 on the downstream side of the three-way valve 14 communicate with each other.

The effects of the first metal pipe 40, the second metal pipe 42, and the third metal pipe 44 will be described. In the FC system 2, the auxiliary machine such as the radiator 16, the pump 18, and the intercooler 20 disposed in the same cooling flow passage 10 as the FC stack 12 may be charged through the coolant.

In the FC system 2 of the present embodiment, the first metal pipe 40 is provided between the inflow portion of the FC stack 12 and the inflow portion of the intercooler 20. The second metal pipe 42 is provided between an outflow portion of the FC stack 12 and an outflow portion of the intercooler 20. The first metal pipe 40 and the second metal pipe 42 are configured to be grounded. Therefore, the intercooler 20 is indirectly grounded through the coolant. Therefore, the intercooler 20 is not charged.

In addition, the pump 18 is directly grounded. Therefore, the pump 18 is not charged.

Further, in the FC system 2, the third metal pipe 44 is provided between the outflow portion of the FC stack 12 and the inflow portion of the radiator 16, and the pump 18 is provided between the inflow portion of the FC stack 12 and the outflow portion of the radiator 16. The third metal pipe 44 and the pump 18 are configured to be grounded. Therefore, the radiator 16 is indirectly grounded through the coolant. Therefore, the radiator 16 is not charged.

As described above, the FC system 2 includes the cooling flow passage 10 through which the coolant circulates, and the FC stack 12 provided on the cooling flow passage 10. The FC system 2 also includes intercooler 20 (an example of a “first auxiliary machine”) including the metal component that comes into contact with the coolant. The cooling flow passage 10 includes the stack flow passage 30 in which the FC stack 12 is disposed and the first flow passage 32 in which the intercooler 20 is disposed. A part of the first flow passage 32 includes the first metal pipe 40 and the second metal pipe 42. The intercooler 20 is disposed between the first metal pipe 40 and the second metal pipe 42 in the first flow passage 32. The first metal pipe 40 and the second metal pipe 42 are configured to be grounded.

In the above configuration, the first metal pipe 40 and the second metal pipe 42 are disposed in the cooling flow passage 10 positioned between the FC stack 12 and the intercooler 20. Since the first metal pipe 40 and the second metal pipe 42 are configured to be grounded, the intercooler 20 can be indirectly grounded through the coolant. Therefore, the intercooler 20 disposed in the same cooling flow passage 10 as the FC stack 12 can avoid or suppress charging.

### Second Embodiment

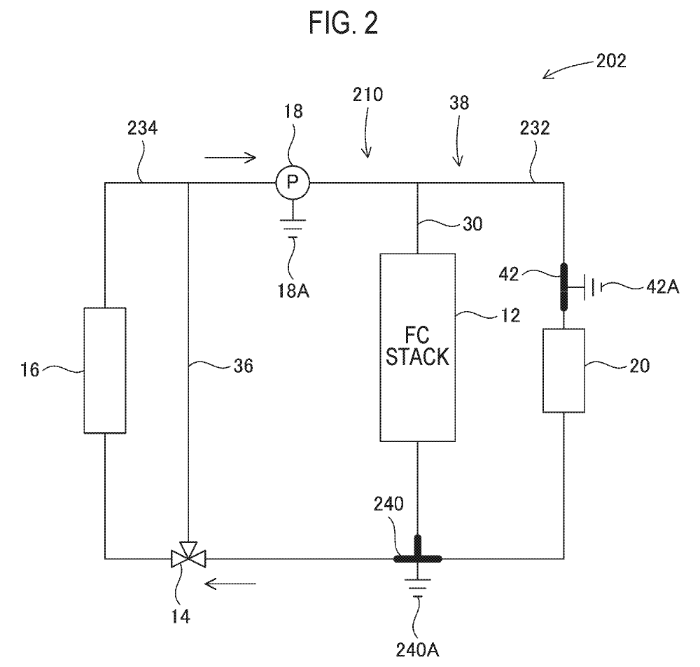

The FC system 202 according to the second embodiment will be described with reference to FIG. 2. In the second embodiment, the configuration of the cooling flow passage 210 is different from the configuration of the cooling flow passage 10 of the first embodiment. In the following, the same reference numerals will be assigned to the configurations common to the embodiments, and the description thereof will be omitted.

As shown in FIG. 2, the cooling flow passage 210 includes the insulating pipes 38 and the metal pipes. The metal pipes include a first metal pipe 240 and the second metal pipe 42. The first metal pipe 240 is a three-way joint that connects the downstream end of the stack flow passage 230, the downstream end of the first flow passage 232, and the upstream end of the second flow passage 234 to each other. That is, the first metal pipe 240 connects three insulating pipes 38. The stack flow passage 230 includes the insulating pipe 38 and the first metal pipe 240. In addition, the first flow passage 232 includes the insulating pipe 38, the first metal pipe 240, and the second metal pipe 42. Further, the second flow passage 234 includes the insulating pipe 38 and the first metal pipe 240.

As described above, the FC system 2 includes the radiator 16 (an example of a “second auxiliary machine”) provided on the cooling flow passage 10, the radiator 16 including the metal component that comes into contact with the coolant. The cooling flow passage 10 includes the second flow passage 234 in which the radiator 16 is disposed. The first metal pipe 240 is a metal joint component that connects the downstream end of the stack flow passage 230, the downstream end of the first flow passage 232, and the upstream end of the second flow passage 234 to each other. Examples of the downstream end of the stack flow passage 230, the downstream end of the first flow passage 232, and the upstream end of the second flow passage 234 are a first end of the stack flow passage, a first end of the stack flow passage, and a first end of the second flow passage, respectively.

According to the above configuration, the number of metal pipes can be reduced as compared to a configuration in which the metal pipe is provided on both the upstream side of the radiator 16 in the second flow passage 234 and the downstream side of the intercooler 20 in the first flow passage 232.

In addition, the FC system 202 further includes the pump 18 (an example of a “third auxiliary machine”) that is provided on the second flow passage 234, the pump 18 including the metal component that comes into contact with the coolant. The pump 18 is configured to be grounded. The radiator 16 is disposed between the pump 18 and the first metal pipe 240 in the second flow passage 234.

According to the above configuration, the first metal pipe 240 and the pump 18 are disposed in the cooling flow passage 210 positioned between the FC stack 12 and the radiator 16. Since the first metal pipe 240 and the pump 18 are configured to be grounded, the radiator 16 can be indirectly grounded through the coolant. Therefore, the radiator 16 disposed in the same cooling flow passage 210 as the FC stack 12 can avoid or suppress charging. Therefore, the metal pipe may not be provided on the downstream side of the radiator 16 in the second flow passage 234. Therefore, the number of metal pipes can be reduced.

### Third Embodiment

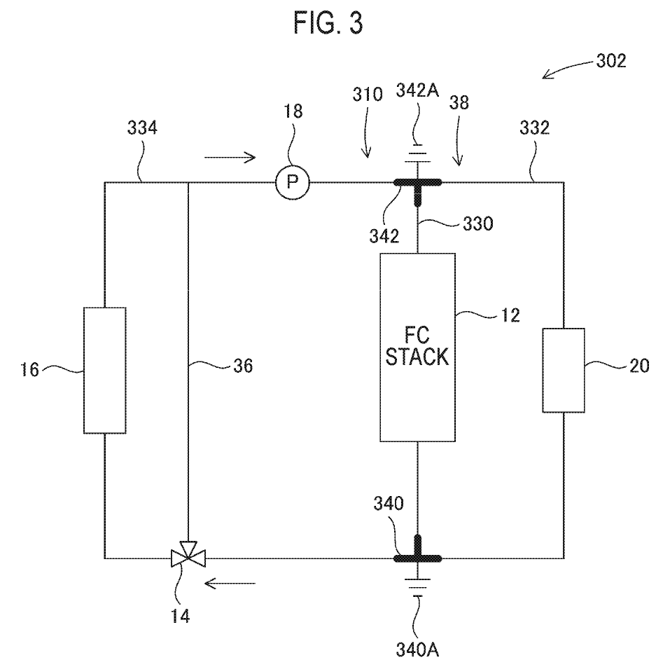

The FC system 302 according to the third embodiment will be described with reference to FIG. 3. In the third embodiment, the configuration of the cooling flow passage 310 is different from the configuration of the cooling flow passage 10 of the first embodiment. In addition, in the third embodiment, the pump 18 is not configured to be grounded.

As shown in FIG. 3, the cooling flow passage 310 includes the insulating pipes 38 and the metal pipes. The metal pipes include a first metal pipe 340 and a second metal pipe 342. The first metal pipe 340 is a three-way joint that connects the downstream end of the stack flow passage 330, the downstream end of the first flow passage 332, and the upstream end of the second flow passage 334 to each other. The second metal pipe 342 is a three-way joint that connects the upstream end of the stack flow passage 330, the upstream end of the first flow passage 332, and the downstream end of the second flow passage 334 to each other. That is, the first metal pipe 340 and the second metal pipe 342 connect three insulating pipes 38. The stack flow passage 330, the first flow passage 332, and the second flow passage 334 include the insulating pipes 38, the first metal pipe 340, and the second metal pipe 342. The first metal pipe 340 and the second metal pipe 342 are electrically connected to grounds 340A, 342A, respectively.

As described above, the second metal pipe 342 may be a metal joint component that connects the downstream end of the stack flow passage 330, the downstream end of the first flow passage 332, and the upstream end of the second flow passage 334 to each other. Examples of the downstream end of the stack flow passage 330, the downstream end of the first flow passage 332, and the upstream end of the second flow passage 334 are the second end of the stack flow passage, the second end of the first flow passage, and the second end of the second flow passage, respectively.

According to the above configuration, the number of metal pipes can be reduced as compared to a configuration in which the metal pipe is provided on both the downstream side of the radiator 16 in the second flow passage 334 and the upstream side of the intercooler 20 in the first flow passage 332.

### Fourth Embodiment

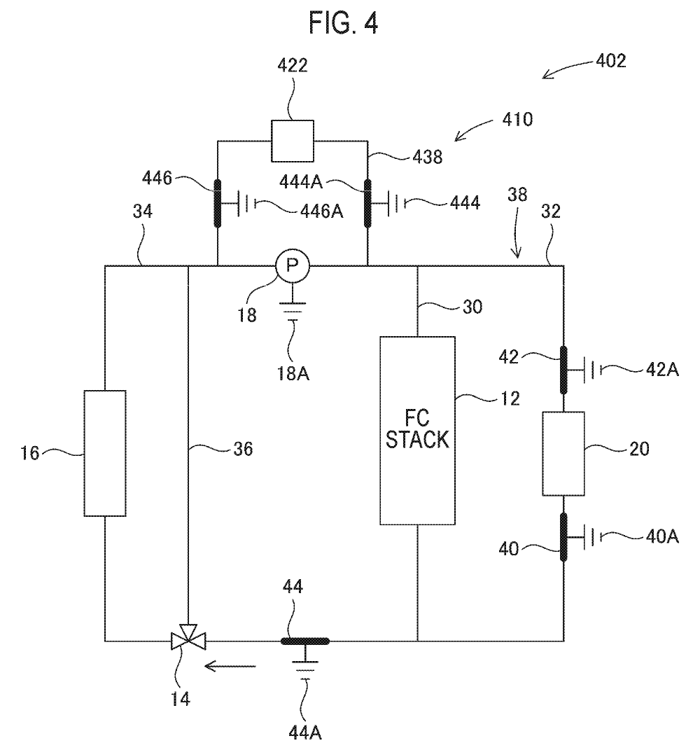

The FC system 402 according to the fourth embodiment will be described with reference to FIG. 4. In the fourth embodiment, the configuration of the cooling flow passage 410 is different from the configuration of the cooling flow passage 10 of the first example. In addition, the FC system 402 of the fourth embodiment further includes an ion exchanger 422. The ion exchanger 422 removes ions from the coolant.

As shown in FIG. 4, the cooling flow passage 410 includes the stack flow passage 30, the first flow passage 32, the second flow passage 34, the first bypass flow passage 36, and a second bypass flow passage 439.

The second bypass flow passage 439 bypasses the second flow passage 34. The upstream end of the second bypass flow passage 439 is connected to the second flow passage 34 between the pump 18 and a connection portion between the downstream end of the first bypass flow passage 36 and the second flow passage 34. The downstream end of the second bypass flow passage 439 is connected to the second flow passage 34 between the pump 18 and a connection portion between the stack flow passage 30, the first flow passage 32, and the second flow passage 34. The ion exchanger 422 is provided in the second bypass flow passage 439. The second bypass flow passage 439 includes the insulating pipes 38, a third metal pipe 444, and a fourth metal pipe 446. The fourth metal pipe 446 is provided on the upstream side of the third metal pipe 444. The third metal pipe 444 and the fourth metal pipe 446 connect two insulating pipes 38 constituting the second bypass flow passage 439. The ion exchanger 422 is disposed between the third metal pipe 444 and the fourth metal pipe 446. The third metal pipe 444 and the fourth metal pipe 446 are configured to be grounded. Specifically, the third metal pipe 444 and the fourth metal pipe 446 are electrically connected to grounds 444A, 446A, respectively.

Although specific examples of the technology disclosed in the present specification have been described in detail above, these examples are merely illustrative and do not limit the scope of the claims. The technology described in the claims includes various modifications and changes of the specific examples exemplified above.

### First Modification

In the first to third embodiments, the ion exchanger may be provided in the first bypass flow passage 36.

### Second Modification

In the first embodiment and the second embodiment, the pump 18 may not be configured to be grounded. In the present modification, the metal pipe that is grounded on the downstream side of the pump 18 in the second flow passages 34, 234 may be provided.

### Third Modification

In the first embodiment and the second embodiment, the intercooler 20 may be configured to be grounded, and the pump 18 may not be configured to be grounded. In the present modification, the FC systems 2, 202 may not have the first metal pipe 40 and the second metal pipe 42. In addition, in the present modification, the metal pipe that is grounded on the downstream side of the pump 18 in the second flow passages 34, 234 may be provided. In the present modification, the radiator 16 and the pump 18 are examples of the “first auxiliary machine”, and the metal pipe provided on the downstream side of the pump 18 in the third metal pipe 44 and the second flow passages 34, 234 are examples of the “first metal pipe” and the “second metal pipe”, respectively.

### Fourth Modification

In the fourth embodiment, the intercooler 20 and the radiator 16 may be configured to be grounded. In the present modification, the FC system 402 may not have the first metal pipe 40, the second metal pipe 42, and the third metal pipe 44. In the present modification, the ion exchanger 422 is an example of the “first auxiliary machine”, and the third metal pipe 444 and the fourth metal pipe 446 are examples of the “first metal pipe” and the “second metal pipe”, respectively.

The technical elements described in the present specification or the drawings exhibit technical usefulness alone or in various combinations and are not limited to the combinations described in the claims at the time of filing. Moreover, the technology exemplified in the present specification or the drawings can achieve a plurality of objectives at the same time, and achieving one of the objectives has technical usefulness.

What is claimed is:

1. A fuel cell system comprising:
a cooling flow passage through which coolant circulates;
a fuel cell stack provided on the cooling flow passage; and
a first auxiliary machine provided on the cooling flow passage, the first auxiliary machine including a metal component that comes into contact with the coolant, wherein
the cooling flow passage includes a stack flow passage in which the fuel cell stack is disposed and a first flow passage in which the first auxiliary machine is disposed,
a part of the first flow passage includes a first metal pipe and a second metal pipe,
the first auxiliary machine is disposed between the first metal pipe and the second metal pipe in the first flow passage, and
the first metal pipe and the second metal pipe are configured to be grounded.

2. The fuel cell system according to claim 1, further comprising a second auxiliary machine provided on the cooling flow passage, the second auxiliary machine including a metal component that comes into contact with the coolant, wherein:
the cooling flow passage further includes a second flow passage in which the second auxiliary machine is disposed; and
the first metal pipe is a metal joint component connecting a first end of the stack flow passage, a first end of the first flow passage, and a first end of the second flow passage to each other.

3. The fuel cell system according to claim 2, further comprising a third auxiliary machine provided on the second flow passage, the third auxiliary machine including a metal component that comes into contact with the coolant, wherein:
the third auxiliary machine is configured to be grounded, and
the second auxiliary machine is disposed between the third auxiliary machine and the first metal pipe in the second flow passage.

4. The fuel cell system according to claim 2, wherein the second metal pipe is a metal joint component connecting a second end of the stack flow passage, a second end of the first flow passage, and a second end of the second flow passage to each other.

5. The fuel cell system according to claim 1, wherein the first auxiliary machine is an intercooler, a radiator, or another heat exchanger.
